(19) United States
(12) Patent Application Publication
(10) Pub. No.: US 2015/0205033 A1
(43) Pub. Date: Jul. 23, 2015

(54) INTEGRATING COLOR FILTERS INTO FRONTLIGHT FOR REFLECTIVE DISPLAY

(71) Applicant: QUALCOMM MEMS Technologies, Inc., San Diego, CA (US)

(72) Inventor: John Hyunchul Hong, San Clemente, CA (US)

(73) Assignee: QUALCOMM MEMS Technologies, Inc., San Diego, CA (US)

(21) Appl. No.: 14/206,729

(22) Filed: Mar. 12, 2014

Related U.S. Application Data
(60) Provisional application No. 61/930,638, filed on Jan. 23, 2014.

(51) Int. Cl. F21V 8/00; G02F 1/1333; G09G 3/36; F21V 9/14

(52) U.S. Cl. CPC G02B 6/0045; G02B 6/0055; G02B 6/005; F21V 9/14; G02F 1/13338; G09G 3/36

(57) ABSTRACT

A light guide may include a light guide core, light-extracting elements and cladding layers having lower refractive indices than that of the light guide core. The light guide may be a component of a front light system for a display. The display may be a reflective display, such as a reflective liquid crystal display (LCD). One cladding layer may include color filters for the display and may be disposed between the light guide and the display. The front light system may include a light source system capable of providing light (which may be polarized) to the light guide. The light-extracting elements may be capable of extracting light from the light guide and providing extracted light to the display, via the color filters. The light-extracting elements may include electrodes, such as electrodes for a touch sensor system.

### CROSS-REFERENCE TO RELATED APPLICATIONS

This disclosure claims priority to U.S. Provisional Patent Application No. 61/930,638 (Attorney Docket No. QUALP216PUS/134721P1), filed Jan. 23, 2014, entitled “INTEGRATING COLOR FILTERS INTO FRONTLIGHT FOR REFLECTIVE DISPLAY.” The disclosure of the prior application is considered part of, and is incorporated by reference in, this disclosure.

### TECHNICAL FIELD

This disclosure relates generally to display devices for actively displaying images. More specifically, some implementations relate to light guides and/or front light systems for display devices.

### DESCRIPTION OF THE RELATED TECHNOLOGY

Reflected light is used to form images in reflective display devices. The perceived brightness of these displays depends upon the amount of light that is reflected towards a viewer. In low ambient light conditions, light from an artificial light source is used to illuminate the reflective pixels, which then reflect the light towards a viewer to generate an image. To meet market demands and design criteria, new illumination devices are continually being developed to meet the needs of display devices, including reflective and transmissive displays.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus capable of providing light to a display. The apparatus may include a light guide core, a first cladding layer disposed between the light guide core and the display, and light-extracting elements capable of extracting light from the light guide and providing extracted light to the display via the color filters. The a first cladding layer may be disposed between the light guide core and the display. The a first cladding layer may have a lower refractive index than that of the light guide core and may include color filters for the display. In some implementations, the apparatus also may have a light source system capable of providing polarized light to the light guide.

In some implementations, the first cladding layer may include binder material having a lower refractive index than that of the light guide core and color filter material in the binder material. The color filter material may include nanoparticles and/or absorptive dyes.

According to some examples, the first cladding layer may include a low refractive index sub-layer and a sub-layer of color filters. The sub-layer may, for example, have a refractive index in the range of 1.36 to 1.41.

In some implementations, the light-extracting elements may include electrodes. At least some of the electrodes may be electrodes of a touch sensor system.

According to some implementations, the apparatus may include a reflective display. In some such implementations, the reflective display may include a liquid crystal layer.

According to some examples, the apparatus may have a polarizing element disposed on at least one surface of the light guide. For example, the polarizing element may be a polarizing layer that is substantially parallel to a plane of the light guide core. In some implementations, the apparatus may include a second cladding layer disposed between the light guide core and the polarizing layer. For example, the light extracting elements may be disposed on the second cladding layer. In some implementations, the polarizing element may be disposed between the light guide and a light source of the light source system.

The reflective display may include an array of display pixels. The apparatus may have a control system capable of processing image data and of controlling the array of display pixels according to the processed image data. In some examples, the control system may include a driver circuit capable of sending at least one signal to the array of display pixels, a controller capable of sending at least a portion of the image data to the driver circuit and an image source module capable of sending the image data to the control system. The image source module may include a memory device, a network interface, a receiver, a transceiver and/or a transmitter. The apparatus may include an input device capable of receiving input data and of communicating the input data to the control system.

Other innovative aspects of the subject matter described in this disclosure can be implemented in a front light system capable of providing light to a display. The front light system may include a light guide and a light source system capable of providing light to the light guide. The light guide may include a light guide core and a first cladding layer disposed between the light guide core and the display. The first cladding layer may have a lower refractive index than that of the light guide core. The first cladding layer may include color filters for the display. The light guide may include light-extracting elements for extracting light from the light guide and for providing extracted light to the display via the color filters.

The front first cladding layer may include low refractive index material and color filter material. In some implementations, the low refractive index material may have a refractive index in the range of 1.36 to 1.41.

In some examples, the front light system may include apparatus for providing polarized light to the light guide. In some implementations, the display may be a reflective display. The front light system may include apparatus for polarizing light reflected from the reflective display.

According to some implementations, the light-extracting elements may include electrodes. At least some of the electrodes may be electrodes of a touch sensor system.

Other innovative aspects of the subject matter described in this disclosure can be implemented in an apparatus that includes a reflective display and a front light system capable of providing light to the reflective display. The front light system may include a light guide and a light source system capable of providing light to the light guide. The light guide may include: a light guide core; a first cladding layer disposed between the light guide core and the display, the first cladding layer having a lower refractive index than that of the light guide core, the first cladding layer including color filters for the display; and light-extracting elements capable of extracting light from the light guide and providing extracted light to the display via the color filters.

In some implementations, the first cladding layer may include low refractive index material and color filter material. For example, the low refractive index material may have a refractive index in the range of 1.36 to 1.41.

In some implementations, the front light system may include apparatus for providing polarized light to the reflective display. The front light system may include apparatus for polarizing light reflected from the reflective display. For example, the apparatus may include a second cladding layer disposed between the light guide core and the apparatus for polarizing light reflected from the reflective display.

According to some implementations, at least some of the light-extracting elements may be capable of functioning as electrodes. For example, at least some of the electrodes may be electrodes of a touch sensor system.

Other innovative aspects of the subject matter described in this disclosure can be implemented in various methods. Some such methods may involve extracting light from a light guide core and providing the extracted light to a display. The providing process may involve directing the extracted light through color filters in a cladding layer disposed between the light guide core and the display.

According to some examples, the extracting may be performed by light-extracting elements. Some such methods may involve controlling the light-extracting elements to function as electrodes of a touch sensor system.

Some methods may involve providing polarized light to the display. In some implementations, the display may be a reflective display. Some such methods may involve polarizing light reflected from the reflective display.

Some methods disclosed herein may be performed, at least in part, according to software stored in a non-transitory medium. The software may include instructions for controlling one or more devices. For example, such non-transitory media may include random-access memory (RAM), read-only memory (ROM), flash memory, optical disk storage, magnetic disk storage or other magnetic storage devices, etc.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A is an example of an illustration of a display being illuminated by an illumination device.

FIG. 1B is an example of an illustration of a display with an illumination device and a touch sensor.

FIG. 1C is an example of an illustration of an implementation of a display with an integrated illumination device with touch sensor.

FIG. 2A is an example of an illustration of an implementation of a light guide.

FIG. 2B is an example of an illustration of an implementation of a light guide with metalized light-turning features.

FIG. 2C is an example of a cross-sectional view of an implementation of a light guide with metalized light-turning features with integrated touch sensor.

FIG. 2D is an example of an illustration of a cross-sectional view of an implementation with metalized-light-turning features and touch-sensing electrodes.

FIG. 3A is an example of an illustration of an implementation of a touch sensor.

FIGS. 3B-3C are examples of illustrations of implementations of illumination devices with an integrated touch sensor.

FIG. 4A is an example of an illustration of an implementation of a light guide with metalized light-turning features integrated with a touch sensor.

FIG. 4B is an example of an illustration of an implementation of a light guide with layers of material deposited on the surfaces of light-turning features and structures composed of those layers formed outside of the light-turning features.

FIGS. 5A-5B are examples of illustrations of implementations of light guides with metalized light-turning features with integrated touch sensor.

FIG. 6A is a block diagram that illustrates examples of light guide elements.

FIG. 6B is a block diagram that illustrates an example of a front light system that includes the light guide of FIG. 6A.

FIG. 7A is a cross-section through one example of a front light system.

FIG. 7B shows an example of light traveling within a light guide.

FIG. 7C is a cross-section through an alternative example of a front light system.

FIG. 8 is a block diagram that illustrates examples of display device elements.

FIG. 9 is a cross-section through an example of a display device such as that shown in FIG. 8.

FIG. 10 is a cross-section through an alternative example of a display device such as that shown in FIG. 8.

FIG. 11 is a flow diagram that provides an example of a method of using a front light system.

FIGS. 12A and 12B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Various implementations disclosed herein include a light guide. The light guide may include a light guide core, light-extracting elements and cladding layers having lower refractive indices than that of the light guide core. The light guide may be a component of a front light system for a display. The display may be a reflective display, such as a reflective liquid crystal display (LCD). A cladding layer may include color filters for the display and may be disposed between the light guide and the display. The front light system may include a light source system capable of providing light (which may be polarized) to the light guide. The light-extracting elements may be capable of extracting light from the light guide and providing extracted light to the display, via the color filters. The light-extracting elements may include electrodes, such as electrodes for a touch sensor system. The light-extracting elements also may be referred to herein as “light-turning features.”

Particular implementations of the subject matter described in this disclosure can be implemented to realize one or more of the following potential advantages. For example, in a typical reflective LCD, the color filters would need to be fabricated in a separate layer. Including the color filters in a cladding layer of the front light system can decrease the overall device thickness. Moreover, electrodes of a touch sensor system are typically provided in “front of screen” plastic laminates. If the light-extracting elements of the front light system include electrodes for a touch sensor system, the overall device thickness may be decreased still further. In some implementations, the electrodes and/or cladding layer with color filters may be manufactured using the same deposition and lithographic processes used for fabrication of the front light system, thereby potentially simplifying the manufacturing processes.

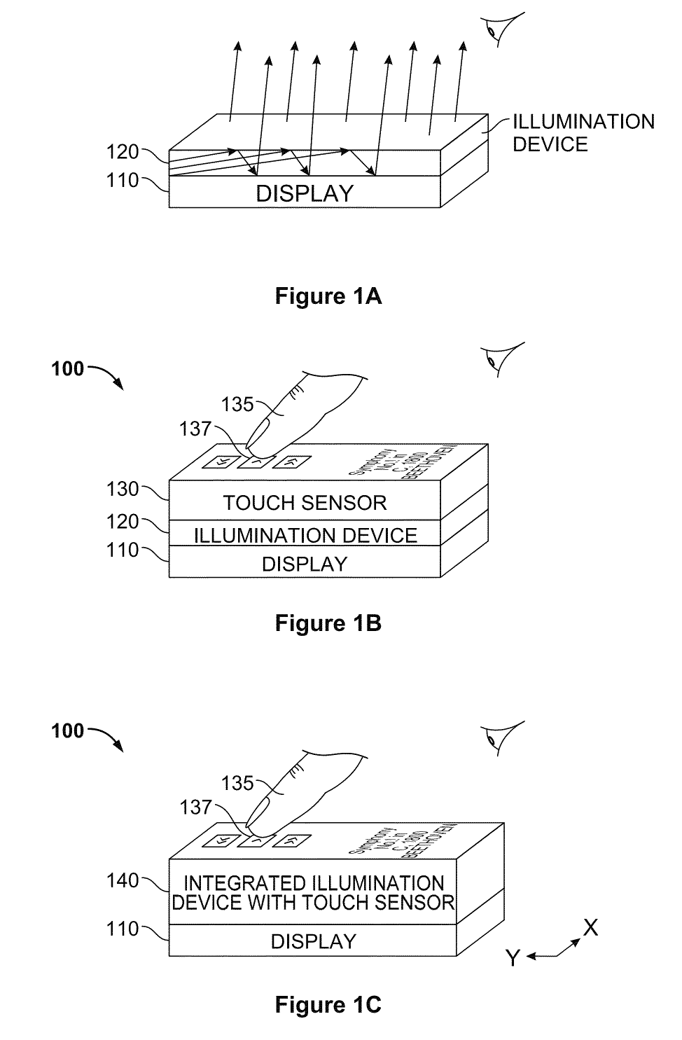

Reflective displays may reflect ambient light towards a viewer thereby providing the viewer with a displayed image. However, in some circumstances, reflective displays such as the display 110 shown in FIG. 1A, may require additional illumination to properly display an image. FIG. 1A is an illustration of a display being illuminated by an illumination device. A reflective display, such as an interferometric modulator display or other reflective display, may require an illumination device 120 to illuminate the display 110 in order for the image to be seen by a viewer. This may be desirable when ambient light, even if present, is not sufficient to fully illuminate the display. In some implementations, illumination device 120 may include a front light with turning features to turn light guided within the light guide towards the display 110 allowing the turned light to reflect off of the display 110 towards the viewer. Light may be injected into light guide 120 by one or more LEDs coupled to the illumination device 120 (LED(s) not shown). Alternatively, in some other implementations, an LED may be coupled into an edge bar (not shown) which may then spread the light along the width of light guide 120 to be guided within light guide 120 and then ejected towards the display 110 to illuminate the display 110.

In some implementations, it may be desirable to additionally include touch sensor capability for a display device 100, as shown in the implementation of FIG. 1B. FIG. 1B is an example of an illustration of a display with an illumination device and a touch sensor. As shown in the implementation of FIG. 1B, display 110 is illuminated with illumination device 120. Stacked over the illumination device is touch sensor 130. Touch sensor 130 is capable of determining the location of a touch by sensing a change to the capacitance of a conductor formed in the touch sensor 130, wherein the change to the capacitance of the conductor is induced by the proximity of a human finger 135. The use of touch sensor 130 with illumination device 120 allows for the useful interaction of the user's finger with the display device 100. For example, by touching the screen in different locations, the user may use his or her finger 135 to select a certain icon 137 displayed on the display 110 of the display device 100. In some implementations, illumination device 120 is not integrated with touch sensor 130. Therefore, illumination device 120 and touch sensor 130 are mechanically stacked one on top of the other. As shown in FIG. 1B, touch sensor 130 is stacked over the illumination device 120, however, in other implementations, the illumination device 120 may be stacked over the touch sensor 130. As shown, the touch sensor 130 is closer to the user viewing the display 110. In yet other implementations, the touch sensor 130 may be behind the display 110.

With reference to FIG. 1C, an example of an illustration of an implementation of a display with an integrated illumination device with touch sensor is shown. FIG. 1C shows an illumination device integrated with touch sensor 140 formed over a display 110, the illumination device integrated with touch sensor 140 being closer to the viewer than display 110 on the side of the display 110 that displays an image, i.e., an image-displaying side. The illumination device integrated with touch sensor 140 can simultaneously illuminate the reflective display 110 to provide for illumination while also allowing for touch sensor capability. In various implementations, one or more components of the illumination device integrated with touch sensor 140 simultaneously have illumination as well as touch-sensing function. For example, conductors formed in the illumination device integrated with touch sensor 140 may provide both illumination capabilities as well as touch-sensing capabilities as will be described in greater detail below. As illustrated, illumination device integrated with touch sensor 140 includes one unit or layer. However, it is understood that the illumination device integrated with touch sensor 140 may include multiple layers and components.

In some implementations, illumination device integrated with touch sensor 140 may be capable of determining whether or not a human finger 135 has touched or come into sufficiently close contact with the illumination device integrated with touch sensor 140 so as to effect the capacitance of conductors at least one of which is formed in the illumination device integrated with touch sensor 140. In various implementations, illumination device integrated with touch sensor 140 is capable of determining a location in x-y coordinates of one or more touches onto the illumination device integrated with touch sensor 140 by a human finger 135. The one or more touches on illumination device integrated with touch sensor 140 by a human finger 135 may be simultaneous or temporally isolated. One way of integrating illumination device 120 and touch sensor 130 of FIG. 1B to form an implementation as illustrated in FIG. 1C is to use metalized turning features in the illumination device 120 while simultaneously using the metalized light-turning features of the illumination device as conductors in electrical communication with an touch-sensing electrode system. The touch-sensing electrode system may be capable of sensing a change to a capacitance of the conductor induced by the proximity of a human finger 135.

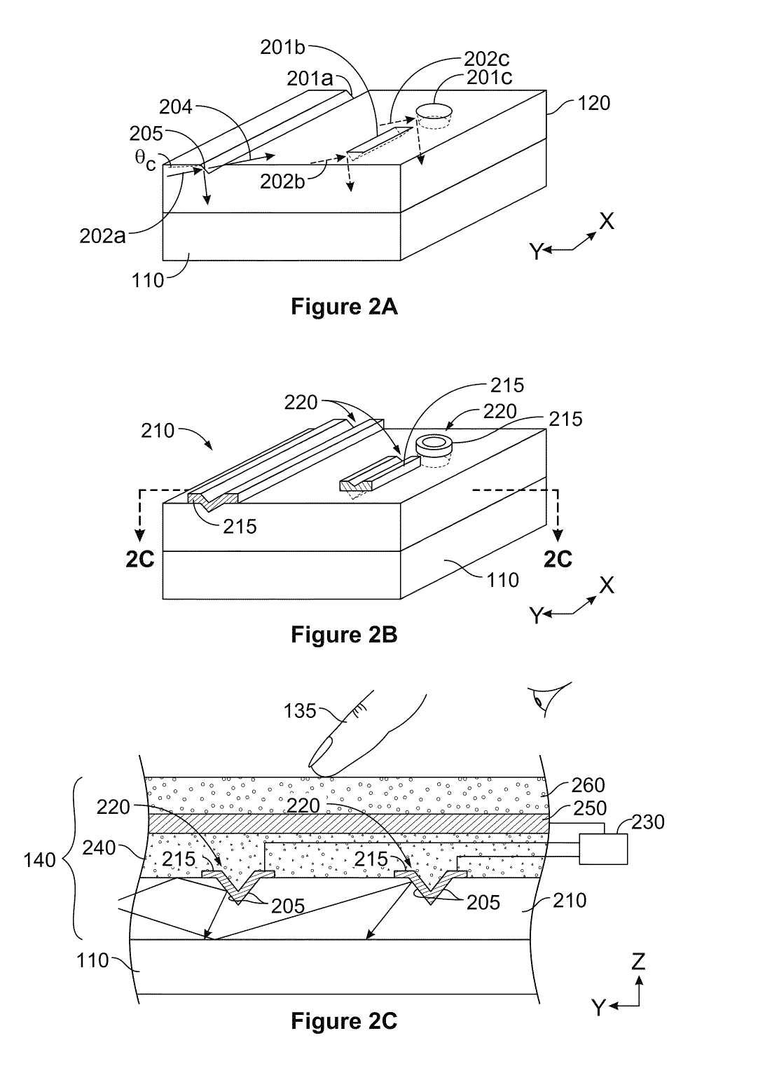

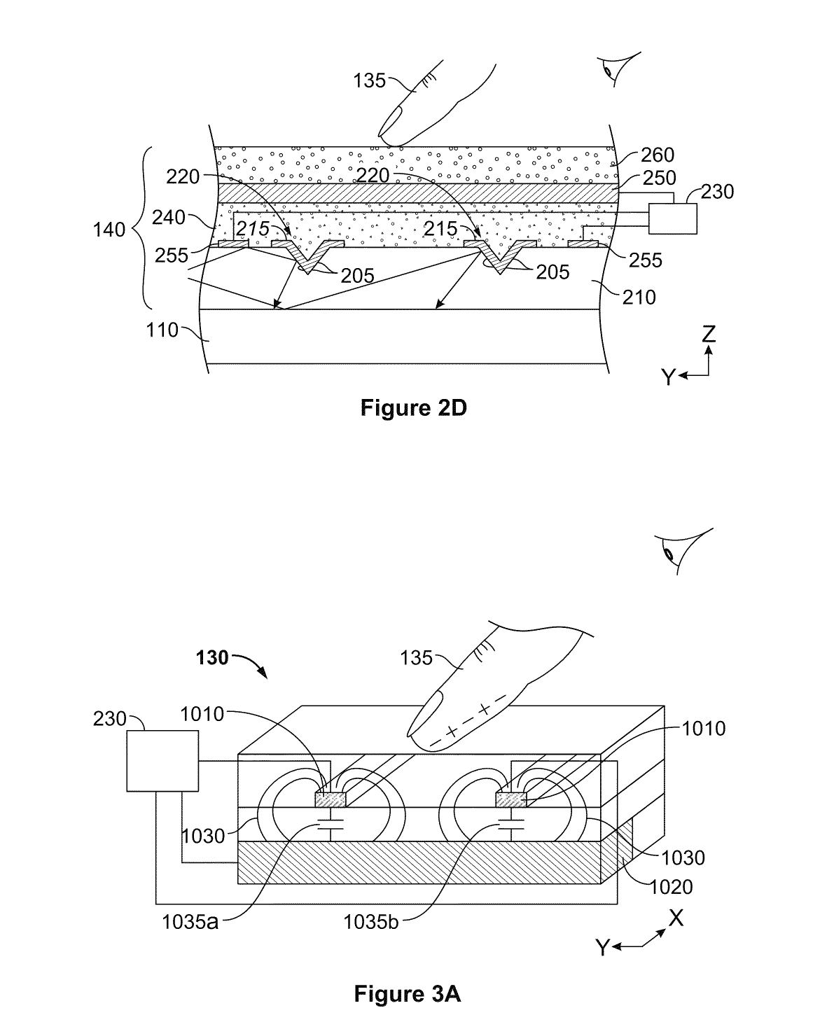

With reference to FIG. 2A, an example of an illustration of an implementation of a light guide is shown. FIG. 2A depicts an implementation of an illumination device 120 comprising light-turning features 201a, 201b, 201c. Such features can “turn” light propagating in light guide 120 out of the light guide and toward a display 110. As shown in FIG. 2A, light-turning features 201a, 201b, 201c include facets 205 that can reflect or turn light. Also as shown in FIG. 2A, light-turning features 201a, 201b, 201c can include multiple different shapes. For example, light-turning features 201a, 201b, 201c may extend longitudinally in one direction, for example, the x direction, as illustrated in feature 201a. In other implementations, the light-turning features 201a, 201b, 201c may include a feature which is discrete, such as 201b and 201c. Also light-turning features 201a, 201b, 201c may include pyramidal, conical, trapezoidal features, other polygonal features, or features of alternative shapes (symmetric or asymmetric) and/or cross-sectional profiles capable of ejecting a light ray 202a, 202b, 202c, toward a display 110. Illumination devices similar to illumination device 120 can be useful in illuminating a display 110 from the front and are often referred to as a “front light.”

In some implementations, it may be useful to form metal conductors on light-turning features 201a, 201b, 201c. A person/one having ordinary skill in the art will understand that light-turning features may include various types of structures, e.g., diffractive and reflective structures, that redirect light. In some implementations, the light-turning features are reflective, with the reflections occurring on surfaces of the light-turning features. These surfaces are commonly referred to as facets. In some implementations, light-turning feature 201a, 201b, or 201c may be defined by a recess in the light guide 120, with the surfaces of the recess constituting one or more facets 205. Light impinging on the facet 205 may be reflected or may pass through the facet depending upon the angle of incidence of the light. For example, as shown by light ray 202a, a light ray propagating in illumination device 120 may sometimes be incident upon a surface of a facet 205 in a light-turning feature 201a, 201b, 201c at an angle that is less than the critical angle (shown in FIG. 2A as θ_{c}), as measured relative to the normal to the facet that the light is incident. As will be understood by those of skill in the art, in such cases light ray 202a may exit the illumination device 120 as shown in escaped light ray 204. Such light is wasted since it is not directed towards display 110 and is therefore not used to illuminate display 110. Indeed, such light will degrade the image of the display 110. It is therefore desirable to construct a light-turning feature 201a, 201b, 201c which will reflect light even if light ray 202a is incident upon light-reflecting facet 205 at an angle that is less than the critical angle. Such a light-turning feature may be formed by forming a metal conductor on the surface of facet 205 thereby “metalizing” the surface of facet 205.

With reference to FIG. 2B, an example of an illustration of an implementation of a light guide with metalized light-turning features is shown. In FIG. 2B, illumination device 210 includes a light guide comprising a conductor 215 formed on a facet of a light-turning feature to form metalized light-turning features 220. Although all of the metalized light-turning features 220 in FIG. 2B are shown fully metalized, it is understood that a metalized light-turning feature 220 need not be completely metalized. For example, a light-turning feature that extends as a long groove (such as, light-turning feature 201a in FIG. 2A) may only be metalized at certain points along the groove (i.e., the x direction), and not along the entirety of the groove. In addition, some light-turning features can be partly and/or completely metalized while others are not metalized. In some implementations, conductor 215 is a reflective or specular metal conductor. As explained above, metalized light-turning features 220 may confer certain advantages over light-turning features that are not metalized. As will be understood by those of skill in the art, the problem discussed above in relation to FIG. 2A of a light ray incident upon a facet of a light-turning feature at an angle below the critical angle is exacerbated when additional layers (with index higher than air) are stacked over a glass or other high index light guide since the low-index layers will increase the critical angle for total internal reflection. This increase in the critical angle will reduce the range of rays ejected by non-metalized light-turning features.

With reference to FIG. 2C, an example of a cross-sectional view of an implementation of a light guide with metalized light-turning features with integrated touch sensor is shown. FIG. 2C depicts an implementation of an illumination device with conductive features integrated into the metalized light-turning features 220. While shown as having a v-like cross-section, it is understood that metalized light-turning features 220 may have various shapes, such as a tapered cylinder or other shape having facets angled to direct light downwards, as indicated, for example, by reference numerals 201a, 201b, and 201c of FIG. 2A. The illumination device includes a light guide 210 comprising metalized light-turning features 220 having light-reflecting conductors 215 formed on a light-turning feature. The illumination device also includes touch-sensing electronics 230 which are electrically connected to light-reflecting conductors 215 and electrodes 250. In some implementations, the light-reflecting conductors 215 may be part of a light-turning feature 220 over the entire length of the light-turning feature 220, or may only extend part of the length of the light-turning features 220, or may extend farther than the length of light-turning features 220. The touch-sensing electronics 230 may be connected to some of the light-reflecting conductors 215, while other light-reflecting conductors 215 are not electrically connect to the touch-sensing electronics 230. In some other implementations, as illustrated, neighboring light-reflecting conductors 215 may be electrically connected to touch-sensing electronics 230. Additionally, FIG. 2C depicts additional layers formed over the light guide 210. In addition to overcoming problems affiliated with nonmetalized light-turning features as described above, the conductors 215 formed over facets 205 of the light-turning feature 220 may additionally be exploited by being in electrical communication with an electronic system. The conductors 215 may extend partly or completely across a display surface, e.g., completely across the viewable surface of a display. In some implementations, the electronic system includes touch-sensing electronics 230 and the conductors 215 form part of a touch-sensing electrode system. The touch-sensing electrode system may but do not necessarily include a plurality of conductors 215 that are part of metalized light-turning features and a plurality of conductors that are not part of any light-turning feature (which may collectively be referred to as “electrodes”) in electrical communication with touch-sensing electronics 230. Touch-sensing electronics 230 may be capable of detecting a change to a capacitance of the conductor 215 induced by the proximity of a conductive body, for example, a human finger 135, and hence the electrode system as a whole is capable of detecting a change to a capacitance of the conductor 215 induced by the proximity of a human finger 135. Using conductors 215 formed on a light-turning feature also as part of a capacitive touch sensor allows for integrating touch-sensor capability with a light guide.

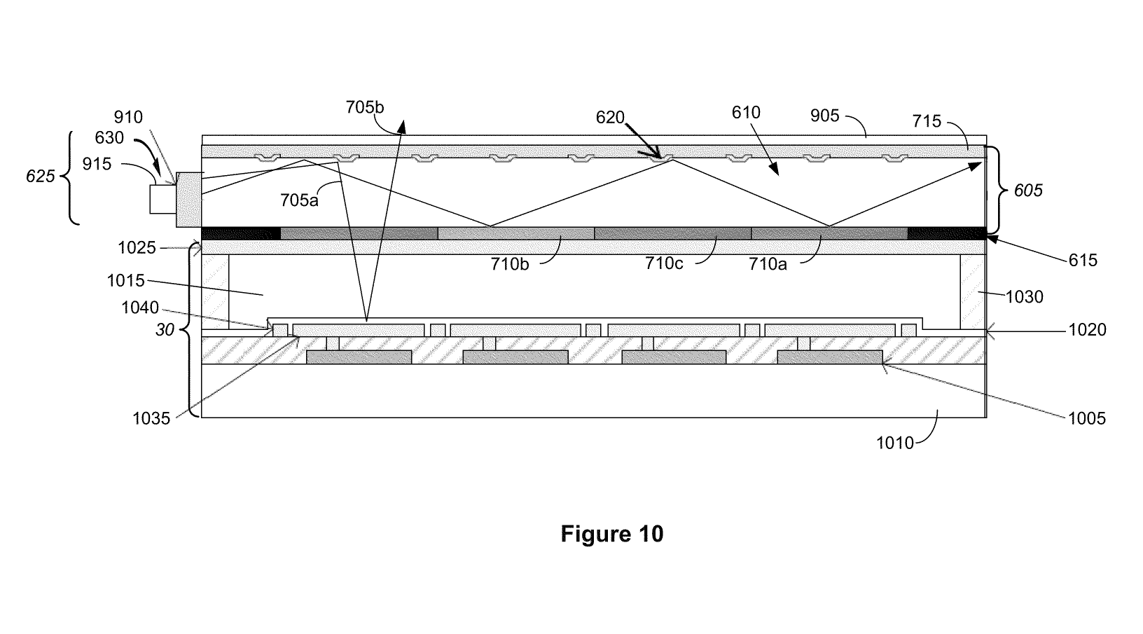

In the implementation illustrated in FIG. 2C, the illumination device integrated with touch sensor capability 140 includes layers over light guide 210, i.e., opposite the light guide 210 from the display 110. For example, layer 240 may be a dielectric layer to electrically isolate conductors 215 from electrode 250 (with electrode 250 extending along the y direction). While only one electrode 250 is shown in the cross-sectional view of FIG. 2C, some implementations may include many electrodes like electrode 250 in parallel extending along the y direction orthogonal to conductors 215. In some implementations, layer 240 may include silicone or other non-corrosive dielectric. Non-corrosive materials are preferred, so as not to degrade or corrupt conductors 215. In some implementations layer 240 may be a pressure sensitive adhesive (PSA) layer that is pressed onto or over light guide 210. Layer 240 may serve other purposes, for example, in implementations without electrodes 250 (see, for example, the implementation of FIG. 10C). Layer 240 may have an index of refraction higher than that of air but lower than about 1.5, or lower than about 1.4, or lower than about 1.35, and therefore, layer 240 formed over light guide 210 may increase the critical angle for light guided in light guide 210. In some implementations, the layer 240 may have an index of refraction of, for example, 1.2 or 1.3. As described above, this may have a negative effect on the turning capability of light-turning features (non-metalized). However, reflective conductors 215 may help reduce these liabilities, and may therefore allow for greater flexibility in designing layers over light guide 210. Additionally, illumination device integrated with touch sensor capability 140 may include other layers, such as passivation layer 260.

With reference to FIG. 2D, an example of an illustration of a cross-sectional view of an implementation with metalized-light-turning features and touch-sensing electrodes is shown. The implementation of FIG. 2D is similar to the implementation of FIG. 2C, except that the touch-sensing electronics 230 is not electrically connected to the metalized light-turning features 220. In such an implementation, touch sensing may be accomplished using a grid of electrodes like electrodes 250 (extending in the y direction) and 255 (extending in the x direction, out of the page). It is understood that, alternatively, the touch-sensing electrode may not be a grid, as, for example, in the implementation of FIG. 10C, and hence may only include electrodes 255 (in which case electrodes 255 may include discrete electrodes) without electrodes 250. Such an implementation may be manufactured using relatively few steps, where electrodes 255 and metalized light-turning features 220 are deposited and etched using the same process, as described in greater detail below. In some other implementations, the touch-sensing electronics 230 can be electrically connected to both the metalized light-turning features 220 and the electrodes 255, in addition to being electrically connected to the electrodes 250, or without being electrically connected to the electrodes 250. In some implementations, only some of the metalized light-turning features 220 are connected to the touch-sensing electronics 230.

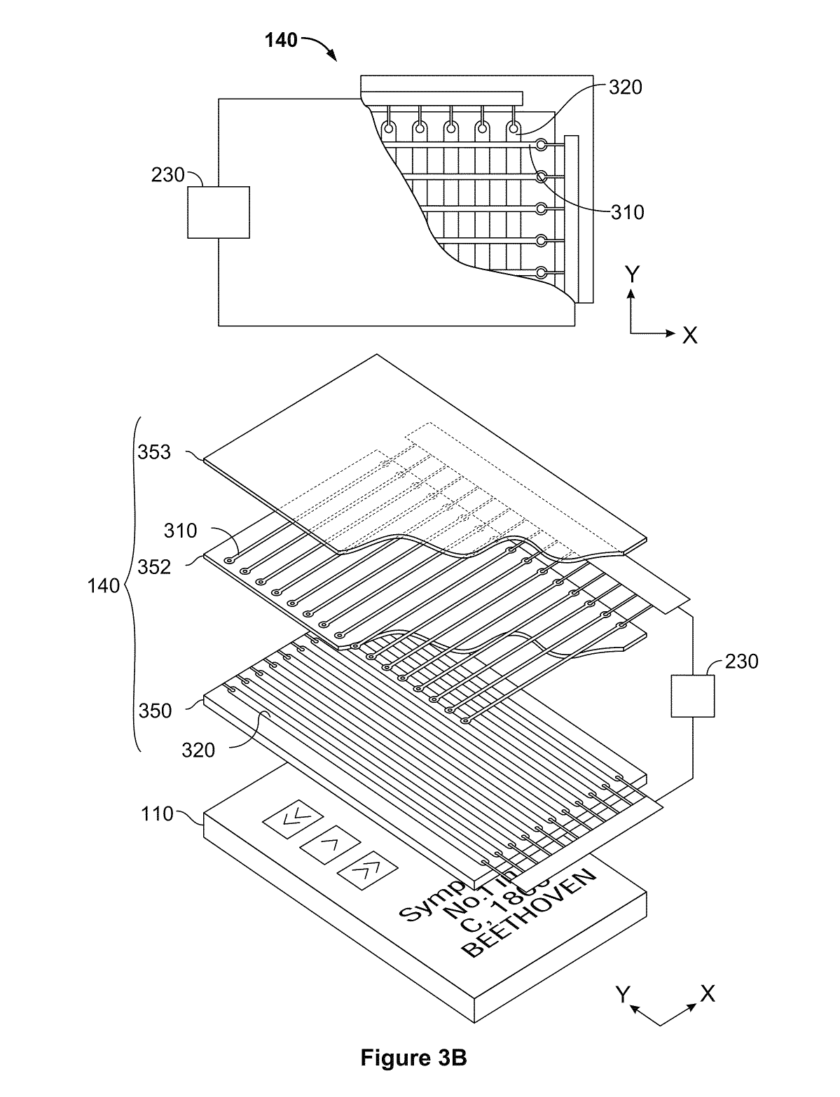

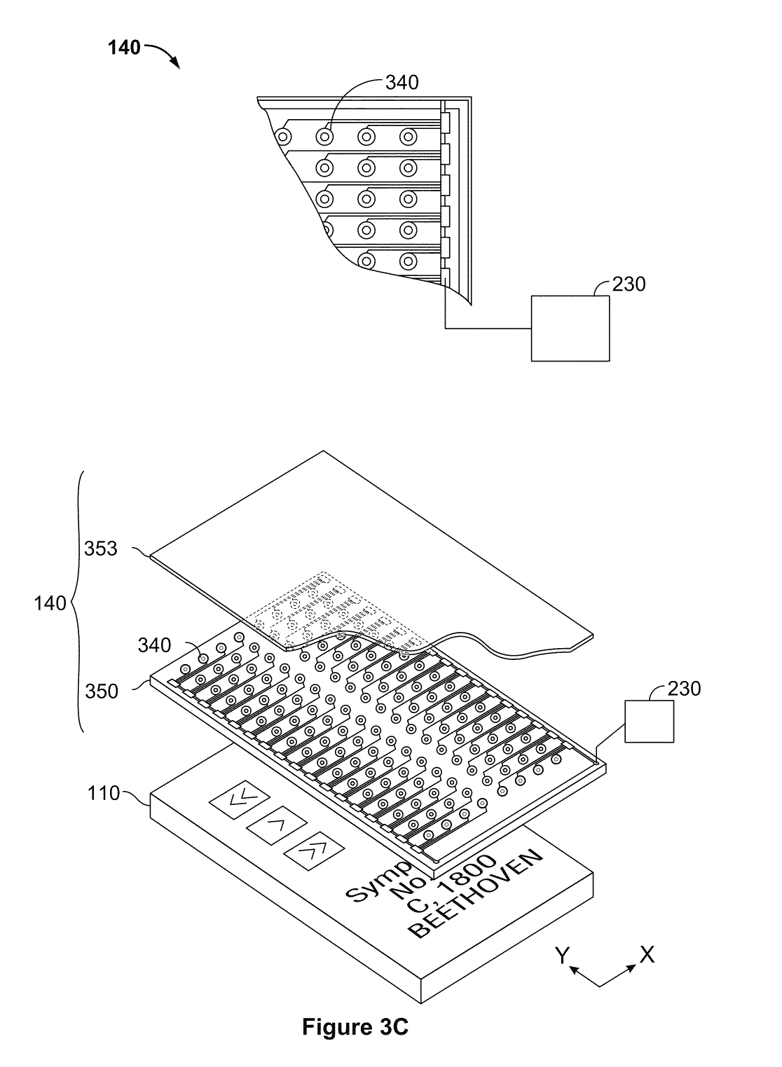

With reference to FIG. 3A, an example of an illustration of an implementation of a touch sensor is shown. The touch sensor may be a capacitive touch sensor. In general, and as depicted in the implementation of FIG. 3A, the capacitive touch sensor includes conductors which serve as electrodes 310, 320. As depicted in the implementation of FIG. 3A, electrodes 310 extend in the x direction, while electrodes 320 extend in the y direction. If a current is passed in one of electrodes 310 or electrodes 320, an electric field, illustrated in FIG. 3A by field lines 330, may form between electrodes 310 and electrodes 320. The electric fields formed between electrodes 310 and 320 are related to a mutual capacitance 335a and 335b. When a human finger 135, or any other conductive body or object, is brought in the proximity of electrodes 310 or 320, charges present in the tissues and blood of the finger may change or affect the electric field formed between electrodes 310 and 320. This disturbance of the electric field may affect the mutual capacitance and can be measured in a change in the mutual capacitance 335a, 335b, which may be sensed by touch-sensing electronics 230. The conductors 215 of FIG. 2C may simultaneously serve the optical functions described elsewhere herein and may serve as electrodes 310 or 320 depicted in FIGS. 3A and 3B or electrodes 340 in FIG. 3C. FIGS. 3B-3C are examples of illustrations of implementations of illumination devices with an integrated touch sensor.

With reference to FIG. 3B, it is understood that in an illumination device integrated with touch sensor 140, layer 350 or 352 may, in some implementations, include a light guide with metalized light-turning features that include some of or a part of electrodes 320 or 310. In implementations where layer 352 is a light guide, electrodes 320 formed beneath layer 352 (between layer 352 and display 110), may be transparent or semi-transparent and include a transparent conductor. Similarly, in some implementations, layer 353 may include a light guide with metalized light-turning features that include some of or a part of electrodes 310.

With reference to FIG. 3B, in some implementations, layer 350 includes a light guide and at least some of or a part of electrodes 320 include at least some metalized light-turning features formed in layer 350. Electrodes 320, including metalized light-turning features, may be formed by a deposition and patterning process. In some implementations, electrodes 310 formed on layer 352 may be laminated or bonded onto layer 350 for convenience and ease of manufacturing.

If the electrodes are in known x-y locations, then the x-y location of a touch by the finger on the touch sensor 130 may also be determined. For example, a touch sensor may include a multitude of electrodes extending in the x direction and a multitude of electrodes extending lengthwise in the y direction and/or periodic in the x direction, as shown in FIG. 3B. The touch-sensing electronics 230 may be capable of isolating or locating or determining x direction electrodes and y direction electrodes that register a change in their mutual capacitances thereby determining the x-y coordinates of the touch. It is understood that a “touch” may include a single touch or multiple touches, whether simultaneous or at different times. “Touch” may also include strokes. It is to be understood that other parts of a human body may be used other than a finger for touching the touch screen. A stylus or any tool capable of affecting the mutual or self capacitance of any electrode system by being in proximity to such system may also be used, such as a conducting body capable of affecting the mutual or self capacitance. Such a tool may be used to touch a display device in order to communicate or input data into a machine using display device simultaneously as an output and as an input device.

In the implementation of FIGS. 3A and 3B, the sensing electronics 230 may sense the mutual capacitance between electrodes 310 extending in the x direction and electrodes 320 extending in the y direction. However, in other implementations, only one level of conductors or electrodes may be used, as illustrated in FIG. 3C. In such an implementation, touch-sensing electronics 230 may be in electrical communication with a series of conductors (electrodes 340 in FIG. 3C) on a touch sensor and may be capable of measuring the self capacitance of the conductors in the touch sensor. The self capacitance is the amount of electrical charge that is added to an isolated conductor to raise its electric potential by one volt. The proximity of a human finger may affect this self capacitance. Touch-sensing electronics 230 may be configured to sense the change in self capacitance. Therefore, in some implementations, a touch sensor may not require a grid of X and Y electrodes but may simply require an array of discrete electrodes 340 (conductors) dispersed in both the X and y direction at known x-y coordinates. As noted above in relation to FIG. 3B, it is understood that in an illumination device integrated with touch sensor 140, layer 350 may, in some implementations, include a light guide with metalized light-turning features that include some of or a part of electrodes 340. Similarly, in some implementations, layer 353 may include a light guide with metalized light-turning features that include a part of electrodes 340. In the illustrated implementation, illumination device integrated with touch sensor 140 is disposed in front of display 110 and functions as a front light.

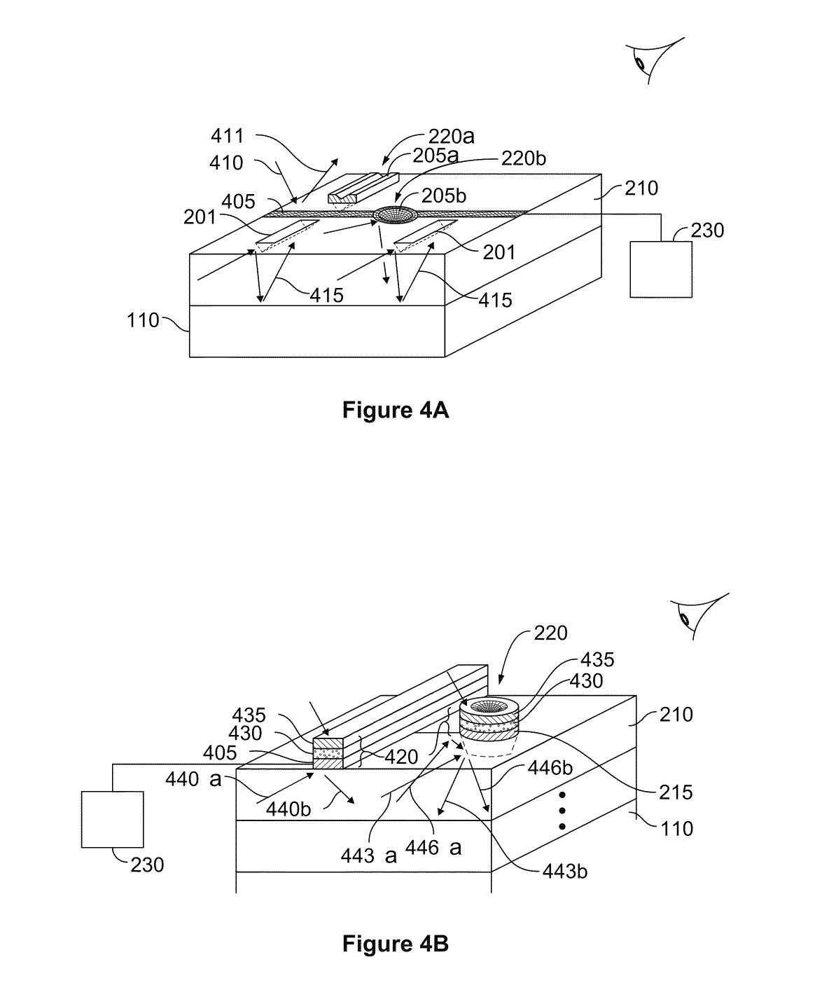

With reference to FIG. 4A, an example of an illustration of an implementation of a light guide with metalized light-turning features integrated with a touch sensor is shown. FIG. 4A depicts a light guide having light-turning features 201 capable of directing light propagating in the light guide 210 towards a display 110. As shown in FIG. 4A, some light-turning features 201 are left unmetalized while others are metalized light-turning features 220a, 220b. It is noted that while metalized light-turning feature 220b is illustrated as completely metalized in order to maximize the light-turning ability of the feature, it is noted that some implementations may include light-turning features with surfaces or facets that are not completely metalized. As also shown in the implementation of FIG. 4A, an auxiliary structure 405 can be formed on the same level as the metalized light-turning features 220a, 220b. As shown in FIG. 4A, the auxiliary structure 405 includes a conductive line. More generally, auxiliary structures can be formed of the same material as the metallization of the metalized light-turning features 220, e.g., by depositing the metallization on the surface of the light guide 210 and then patterning the layer of deposited material to simultaneously define the metallization of the metalized light-turning features 220a, 220b and to form the auxiliary structure 405. In some implementations, the auxiliary structure 405 is a conductive line and the metalized light-turning feature 220b is connected to a touch-sensing electrode system (i.e. electrically connected to other electrodes and conductors and to touch-sensing electronics 230) by the conductive line. The conductive line 405 may include a reflective metal line that connects the conductor of metalized light-turning feature 220b with an electrode system capable of sensing a change to a capacitance of the conductor induced by the proximity of a human finger. In other implementations, conductive line 405 may include a transparent conductor such as indium tin oxide (ITO). As shown in FIG. 4A, not all metalized light-turning features need be integrated or in electrical communication with the touch-sensing electrode system. For example, in order to achieve a desired illumination of a display 110, light-turning features of a certain size and/or density may be advantageous. For example, for a light-turning feature of about 3-30 um size, in some implementations, about 1,000-100,000 features per square cm of light guide may be used. However, given the dimensions of a human finger, the density of conductors in electrical communication with a touch sensing electrode system may be much less. For example, the spacing between electrodes, including metalized light-turning features that are part of the electrode system, may be roughly greater than one per square centimeter. However, the spacing between electrodes may be less in applications where precision is less important. Similarly, the spacing between electrodes may be greater in other applications where high precision is important. Depending upon the density of metalized light-turning features, in some implementations, one in ten, or less, metalized light-turning features may be in electrical communication with the touch-sensing electrode system. Therefore, in some implementations, the number of metalized light-turning features 220 in electrical communication with the touch-sensing electrode system may be far fewer than the number of metalized light-turning features 220. Furthermore, as shown in FIG. 4A, not all light-turning features need be metalized. Also, as shown in FIG. 4A, some light-turning features 220a are completely metalized, while others (e.g., metalized light-turning feature 220b) are only partially metalized.

In implementations where conductive line 405 includes a reflective metallic line, reflections of ambient light may occur that may degrade the image formed on display 110. For example, as shown in FIG. 4A, ambient light ray 410 may be incident on conductive line 405, and may reflect back towards the viewer. These reflections of ambient light may degrade the image displayed on the display as reflected white light may whiten out the (colored) light that is reflected from the display, illustrated as rays 415 in FIG. 4A. Similar reflections from metalized light-turning features 220 may similarly degrade an image displayed on display 110. These reflections of ambient light may, as will be understood by those of skill in the art, lead to contrast ratio reduction. Therefore, it is desirable to mask reflections by metallic surfaces, such as metalized light-turning features 220 or metallic conductive lines 405. One way to accomplish this is to coat metallic surfaces with a thin film interferometric structure in order to reduce or eliminate the reflections that would otherwise lead to contrast ratio reduction.

With reference to FIG. 4B, an example of an illustration of an implementation of a light guide with layers of material deposited on the surfaces of light-turning features and structures composed of those layers formed outside of the light-turning features is shown. FIG. 4B depicts a conductor formed on a light-turning feature to produce a metalized light-turning feature 220, however, additionally, the metalized light-turning feature is masked to reduce or eliminate reflections of ambient light using a thin film interferometric structure 420. Since the reflective conductor may contribute to the interferometric effect, the thin film interferometric structure 420 may also be said to include conductor 215 (or conductive line 405). The thin film interferometric structure 420 includes a spacer layer 430, which can be a dielectric or conductive layer in some implementations, and a thin metal or metal alloy absorber 435. The spacer layer 430 has a thickness, and may include various suitable transparent materials for forming an “optical resonant cavity.” The spacer layer 430 (“optical resonant cavity”) may be formed between the conductor 215 (or conductive line 405) and the absorber 435. The spacer layer 430 may include materials such as air (e.g. using posts to hold up absorber layer 435), Al₂O₃, SiO₂, TiO₂, ITO, Si₃N₄, Cr₂O₃, ZnO, or mixtures thereof. Depending on the thickness of the spacer layer 430, the interferometric structure 420 may reflect a color such as red, blue, or green, or in other implementations, the thickness of the spacer layer 430 may be adjusted so as to provide for little or no reflection (e.g., black). A suitable thickness for spacer layer 330 (other than air) is between 300 Å and 1000 Å to produce an interferometric dark or black effect. Methods of depositing or forming dielectric layers are known in the art, including CVD, as well as other methods. In another implementation, where the spacer layer 330 is a dielectric or insulator, the spacer layer 330 may be formed with an air gap or other transparent dielectric material. A suitable thickness for an air gap dielectric layer 330 is between 450 Å and 1600 Å to produce an interferometric dark or black effect. Other thickness ranges may be used, for example, to achieve other colors such as red, blue, or green.

Also shown in FIG. 4B, formed over the spacer layer 430 is a metallic absorber 435. In the illustrated implementation where the interferometric structure 420 is designed to interferometrically darken the appearance of the naturally reflective conductor 215 formed on the metalized light-turning feature 220 or the conductive line 405, the absorber 435 may include, for example, semi-transparent thicknesses of metallic or semiconductor layers. The absorber 435 may also include materials that have a non-zero extinction coefficient (k). In particular, chromium (Cr), molybdenum (Mo), titanium (Ti), silicon (Si), tantalum (Ta), and tungsten (W) all may form suitable layers. Other materials may be employed. In one implementation, the thickness of the absorber 435 is between 20 Å and 300 Å. In one implementation, the absorber 435 is less than 500 Å, although thicknesses outside these ranges may be employed. As shown in FIG. 4B, in some implementations, interferometric structure 420 may also be formed over a conductive line 405.

While the interferometric structure 420 formed over conductive line 405 or metalized light-turning feature 220 allows for little or no reflection of ambient light towards a viewer, for light propagating within light guide 210, the reflective metalized surface of conductors can reflect light that is guided within the light guide as desired. For example, light traveling within the light guide may reflect off of the metallic surface of the conductive line 405 in such a way so as to continue being guided within the light guide 210, as shown by light rays 440a and 440b. The metal layer 405 may be about 30-100 nm thick in some implementations. Examples of high reflectivity metals for the metal layer 405 include Al, Al alloys, Ag, etc. Similarly, light guided within the light guide may reflect off of the metalized light-turning feature 220 so as to be reflected towards a display to be illuminated 110. For example, light ray 443a and 446a are incident upon the reflective conductor comprising metalized light-turning feature 220 and reflected towards the display 110 to be illuminated as shown by rays 443b and 446b. While illustrated in the implementation of FIG. 4B as preventing reflections of ambient light from metalized light-turning features 220 or conductive line 405, it is understood that interferometric structure 420 may be formed over any reflective surface formed forward of, i.e. closer to a viewer than or on an image-displaying side of, a display 110. As such, for any reflective surface formed on an illumination device, a capacitive touch sensor, or other device formed forward of a display, an interferometric structure 420 may be used to reduce reflections of ambient light so as not to degrade the image on the display. Such reflective conductors may be formed on any component configured to be placed on an image-displaying side of a display, for example, a front light formed over a display, a touch sensor formed over a display, or other device formed forward of a display.

As shown in FIG. 4B, auxiliary structure 405, which may be a conductive line, may be formed on a surface, e.g., the top surface, of the light guide 210, while the conductor 215 is formed in a light-turning feature. As illustrated, the light-turning feature includes a recess formed on the top surface of the light guide 210 and extends down into the light guide 210. The recess can have faceted surfaces for turning light. The conductor 215 formed in the light-turning feature thereby forms a metalized light-turning feature 220. Conductive line 405 and metalized light-turning feature 220 may be efficiently manufactured by depositing a reflective, conducting material, e.g., a metal, on a top surface (including conformally depositing the material in the recesses of the light-turning features formed on the top surface) of the light guide 210 and etching the material to form the conductive line 405 and leaving some of the material in the recess of the light-turning feature to form the metalized light-turning feature 220. In other words, an auxiliary structure such as the conductive line 405 and the metallization in the recesses forming the light-turning features may be formed simultaneously in a single patterning step; it may not be necessary to form conductive line 405 and metalized light-turning feature 220 in separate steps. This may be accomplished on a light guide comprising a substrate, or a light guide comprising an index-matched turning film formed on an optically transparent substrate.

More generally, the conductive line 405 illustrated in FIG. 4B may form part of passive and/or active electronic devices. For example, as discussed herein, the line 405 may be a conductive line 405 such as an electrode. In other implementations, it is possible to deposit many different kinds of materials other than metals on the top surface of the light guide. For example, the deposited material may include semiconductor materials, including a highly reflective semi-conducting material, or a dielectric, or a combination of materials having different electrical properties. In such a way, a single deposition of a particular material may be used to form an auxiliary structure (shown in FIG. 4B as a conducting line 405) on a top surface of a light guide as well as to coat the recess of a light-turning feature formed on the top surface. Similarly, etching the material to form an auxiliary structure and simultaneously leaving some of the material in the recesses of the light-turning features to form material-filled or coated light-turning features may be accomplished using a single patterning process, such as a photolithographic process. Such an auxiliary structure may include a conductive electric trace or other passive electric device. In some implementations, the auxiliary structure may include more than one layer. For example, auxiliary structure may, in some implementations, include layers 405, 430, and 435. As a result, interferometric structure 420, for example, may be considered an auxiliary structure. Where the auxiliary structure includes more than one layer, not all layers of the auxiliary structure need also be used to coat a light-turning feature. More generally, one or more layers used to coat a light-turning feature may also be used to form the auxiliary structure, but it is understood that the auxiliary structure may include layers not included in the coated light-turning feature, and vice versa. In implementations where the auxiliary structure includes multiple layers, multiple layers of materials may be deposited on the light guide in order to form auxiliary structure and to coat the recess of the light-turning feature, and the deposited layer(s) may then be etched to form the auxiliary structure and coated light-turning feature. In various implementations, after etching the deposited material, additional layers may be deposited on the auxiliary structure that are not then formed in the recesses of the light-turning features, and vice versa. Hence, more generally, the auxiliary structure is at least partially formed of the material coating at least some of the recesses.

As illustrated in the implementation of FIG. 4B, conductive line 405 is electrically connected to metalized light-turning feature 220. However, it is understood that such an electrical connection is optional. Hence, in some implementations, not all of the metalized light-turning features are part of an electrode system capable of sensing the proximity of a conductive body (touch-sensing electronics 230). This is because the light-turning features may be very dense (i.e., a large number for light-turning features for a given area), while touch-sensing electrodes need not be as dense. For example, touch-sensing electrodes may be horizontally spaced about 1-10 mm, about 3-7 mm, or about 5 mm apart. Indeed, in some implementations (as in FIG. 2D), no metalized light-turning features may be electrically connected to the touch-sensing electronics 230. As described above, a single material deposition may be used to fabricate such a grid of electrodes as well as to conformally coat the recess of a light-turning feature.

As illustrated in FIG. 4B, the display 110 is not always immediately adjacent to the light guide 210. However, it is to be understood that in some implementations display 110 may be immediately adjacent to the light guide 210 which includes the illumination device illuminating display 110. In other implementations, an air gap may be formed between the light guide 210 and the display 110. Further, in other implementations, there may be one or more layers between light guide 210 and display 110. In such implementations, the one or more layers may or may not include an air gap.

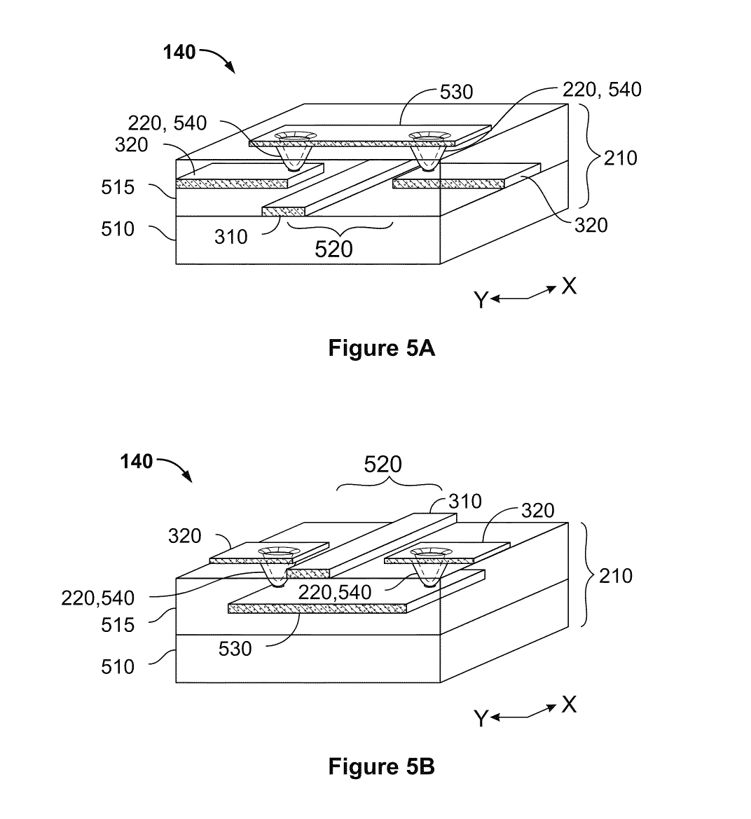

As previously discussed in FIGS. 3A and 3B, some implementations of a touch sensor include a plurality of elongate electrodes elongated along an x direction separated by a dielectric layer and stacked over a plurality of electrodes elongated in a y direction. It may be advantageous in some implementations, however, to form the grid of X and Y electrodes in a single plane or surface. In other words, the grid of X and Y electrodes may be formed on the same surface. In such implementations, the electrodes elongated in one direction, e.g., the x direction, are electrically isolated from the electrodes elongated in the other direction, e.g., the y direction. FIGS. 5A-5B are examples of illustrations of implementations of light guides with metalized light-turning features with integrated touch sensor showing X and Y electrodes formed in a single plane or surface.

For example, in the implementation depicted in FIG. 5A, electrode 310 extends along the x direction and electrode 320 extends along the y direction. Electrode 310 and electrode 320 may be formed in a single plane. In the illustrated implementation in FIG. 5A, electrodes 310 and electrodes 320 are formed on the surface of a glass or other optically transparent substrate 510. In some implementations, the electrodes 310, 320 may be auxiliary structures formed in a manner similar to that of the conductive line 405, as described above regarding FIG. 4B. Over the optical substrate 510 is formed a turning layer 515. The optical substrate 510 and turning layer 515 together make up the light guide 210. While, for the purposes of ease of illustration, turning layer 515 is shown much thicker than substrate 510, in various implementations the substrate 510 may be thicker than the relatively thin turning layer 515. As illustrated in the implementation of FIG. 5A, electrode 320 is patterned so as to provide for a gap 520 to allow electrode 310 to traverse electrode 320 in a direction perpendicular to the direction of electrode 320 so as to isolate electrode 310 and electrode 320. While FIG. 5A illustrates electrodes 310 and 320 as perpendicular from each other, they may be non-parallel but not necessarily perpendicular. The two sides of electrode 320 are bridged over electrode 310 through conductive bridge 530 by forming vias 540 in the turning layer. The vias 540 include facets that may be angled appropriately to turn light guided in light guide 210. The vias 540 are shown formed on both sides of the gap 520. As illustrated, vias 540 are conical, but it is understood that they may be formed in any shape that provides for a facet capable of turning light out of light guide 210, such as pyramidal or other profile (like a line or line segment similar to light-turning features 201a and 201b in FIG. 2A). In one implementation, the vias 540 may be metalized by conformal deposition of the conductive bridge 530 in the vias 540, which expose electrode 320. However, vias 540 may be separately filled with conducting material, which may also be reflective. In one implementation, vias 540 provide a facet that is a 45° angle with respect to a plane parallel to the plane of substrate 510.

Vias 540 may also serve as a metalized light-turning feature 220 in the turning layer 515. Turning layer 515 may include metalized or non-metalized light-turning features other than vias 540. As depicted in FIG. 5A, a pair of metalized light-turning features 220 are formed on opposite sides of electrode 310. Metalized light-turning features 220 act as conductive vias 540 connecting one side of electrode 320 with the other side of electrode 320 along the y direction. Metalized light-turning features 220 may both reflect light towards a display to illuminate a display device while also acting as electrical vias 540 to bridge electrode 320. As such, the conductors formed in metalized light-turning features 220 perform both optical functions in an illumination device and electrical functions in a touch sensor to provide for an “integrated” illumination device with touch sensor capability 140. Hence, metalized light-turning features 220 may be in electrical communication with a larger electrode system that is a touch-sensing electrode system capable of sensing a change to a capacitance of the conductor in the metalized light-turning features 220 induced by the proximity of a human finger.

Electrodes 310 and 320 as well as bridge 530 are conductive and may include reflective metallic conductors or transparent conductors, such as ITO. Preferably, electrodes 310 and 320 are transparent, while bridge 530 is reflective. In such an implementation, reflections of ambient light from bridge 530 may be masked with an interferometric structure similar to that of FIG. 4B. It is understood that the vias 540, electrodes 310 and 320 and bridge 530 may not be drawn to scale. Electrodes 310 and 320 (and to a lesser degree bridge 530) may be patterned to have a small footprint so as to minimize any effect on light propagating in the light guide 210. Hence, electrodes 310 and 320 and bridge 530 may, in some implementations, have a smaller width than via 540. The implementation of FIG. 5A may be formed by depositing and patterning electrodes 310 and 320. Electrodes 310 and 320 and gap 520 may be formed by patterning a standard pre-coated ITO-coated glass substrate which is commercially and readily available. Gap 520 may be approximately 50 μm across, but wider or narrower designs may be employed, such as, for example gaps between about 10-1000 μm, or about 20-500 μm. In such implementations, an ITO-coated glass may be patterned to form electrodes 310 in the x direction and electrodes 320 in the y direction patterned with gaps 520 in one or the other direction to prevent the intersection of electrode lines. In such an implementation, the glass substrate can serve as the substrate of a light guide 210. Then turning layer 515 may be deposited or deposited over substrate 510. In some implementations, layer 515 may be a SiON layer that is index matched to substrate 510. A taper etch process may then be used to define light-turning features and vias 540 in turning layer 515. Vias may be approximately 5 μm across. In some implementations, wider or narrower vias may be employed, e.g., the vias may measure about 2-50, or about 3-30 μm across. Then, a reflective conductor layer may be deposited and etched to provide conductor-filled vias 540, which may also serve as a metalized light-turning feature 220.

With reference to FIG. 5B, another implementation of an electrode system comprising electrodes 310, 320 in the X and y direction formed in a single plane is depicted. In some implementations, the electrodes 310, 320 may be auxiliary structures formed in a manner similar to that of the conductive line 405, as described above regarding FIG. 4B. As in the implementation depicted in FIG. 5A, a light guide 210 includes a glass substrate 510 and a light-turning layer 515. However, the electrodes 310 and 320 and the gap 520 in the present implementation are formed over the light-turning layer 515. In this implementation, the bridge 530 is formed underneath the electrodes 310 and 320 and over the substrate 510. In certain implementations of FIG. 5B, conductive bridge 530 may be formed of a transparent conductor while electrodes 310 and 320 may be formed of reflective metal, and may hence be masked by an interferometric structure as noted above. It is understood that the vias 540, electrodes 310 and 320 and bridge 530 may not be drawn to scale. In some implementations, bridge 530 (and to a lesser degree electrodes 310 and 320) may be patterned to have a smaller width than the diameter of the vias 540, so as to reduce the impact of the bridge 530 on light reflected off the surface of the via 540. In implementations where bridge 530 is wider than vias 540, it may block light that is reflected off vias 540 from propagating downwards to an underlying display. Vias 540 may include metalized light-turning features and may be metalized by conformal deposition of electrode 530 extending into the vias 540. In some implementations, the vias may have dimensions on the order of microns, while the electrode 530 (as well as the conformal coating of the via 540) may have a thickness on the order of one tenth of a micron. Conductive material may be deposited onto substrate 510 and patterned to form conductive bridge 530. In some implementations conductive material may include a transparent conductor. Conductive bridge 530 may be also formed by patterning a standard pre-coated ITO-coated glass substrate which is commercially and readily available. Turning layer 515, light-turning features in turning layer 515, and vias 540 may all then be formed, for example, as described above regarding FIG. 5A. In some implementations, the dimensions for gap 520 and vias 540 in the implementation of FIG. 5B may be similar to those noted above regarding FIG. 5A. In certain implementations, the conductive bridge 530 of the implementation of FIG. 5A and the electrodes 310 and 320 of the implementation of FIG. 5B may be laminated. In one example of such a method, bridge 530 or electrodes 310, 320 may be formed on the bottom of a lamination layer (not shown in FIGS. 5A and 5B), and the layer may then be laminated over turning layer 515 to connect bridge 530 or electrodes 310, 320 with conducting vias 540.

In a typical LCD, a liquid crystal layer is disposed between substantially transparent substrates, such as glass substrates. Color filters are typically formed on one of the substantially transparent substrates. Electrodes of a touch sensor system are typically provided in “front of screen” (FOS) plastic laminates. Some implementations provided herein include the color filters in a cladding layer of a front light system. Alternatively, or additionally, light-extracting elements of the front light system may include electrodes for a touch sensor system. Such implementations may reduce the overall device thickness and may simplify the manufacturing processes.

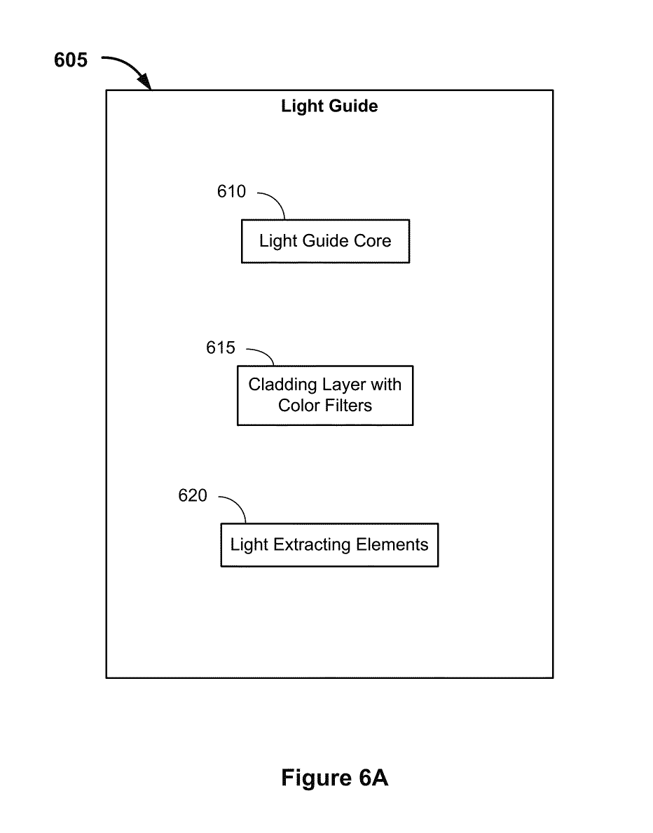

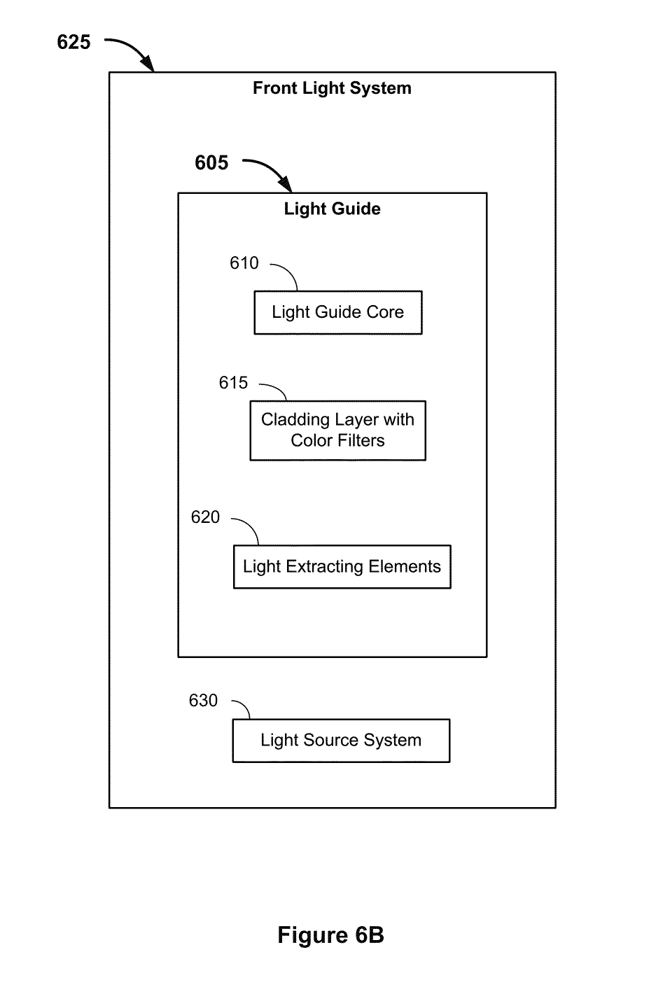

FIG. 6A is a block diagram that illustrates examples of light guide elements. The light guide may be capable of providing light to a display, such as a reflective display. In this example, the light guide 605 includes a light guide core 610, a cladding layer 615 that includes color filters for the display, and light-extracting elements 620. The cladding layer 615 may be disposed between the light guide core and the display and may have a lower refractive index than that of the light guide core. The light-extracting elements 620 may be capable of extracting light from the light guide and providing extracted light to the display, via the color filters.

FIG. 6B is a block diagram that illustrates an example of a front light system that includes the light guide of FIG. 6A. Here, the front light system 625 includes a light source system 630. The light source system 630 may be capable of providing light to the light guide 605.

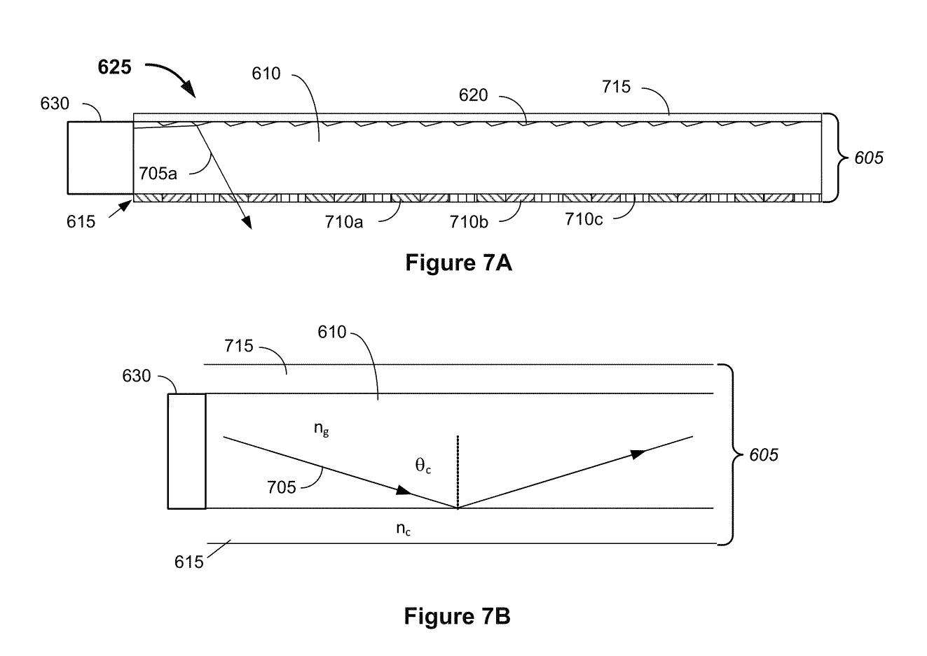

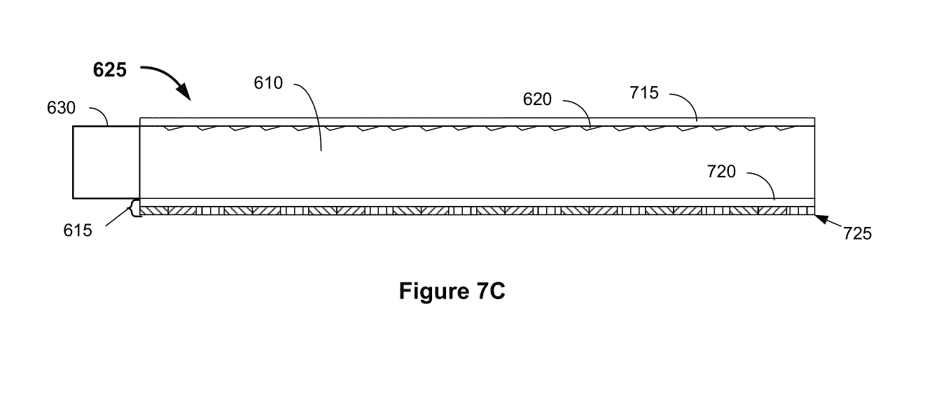

FIG. 7A is a cross-section through one example of a front light system. As with other implementations shown and described herein, the sizes, configurations, numbers and types of elements shown in FIG. 7A are merely examples. In this example, the front light system 625 includes a light guide core 610, a cladding layer 615 that includes color filters for the display, light-extracting elements 620 and a cladding layer 715.

The front light system 625 of FIG. 7A also includes a light source system 630 that is optically coupled to the light guide 605, specifically to the light guide core 610. In some implementations, the light source system 630 is capable of providing polarized light to the light guide 605. For example, the light source system 630 may include a polarizing element (such as a polarizing filter) disposed between the light guide and a light source of the light source system. Alternatively, the light source system 630 may include a source of polarized light, such that a separate polarizing element is not necessary.

The cladding layers 615 and 715 may have lower indices of refraction than that of the light guide core 610. For example, if the light guide core 610 is formed of glass, with an index of refraction of approximately 1.51, the indices of refraction of the cladding layers 615 and 715 may be less than 1.42.

In this example, the cladding layer 615 includes color filters 710a, which are red color filters. Here, the cladding layer 615 also includes color filters 710b, which are green color filters, as well as color filters 710c, which are blue color filters in this example. In alternative examples, the color filters may include other types of color filters, such as yellow color filters.

In implementations such as that shown in FIG. 7A, the color filters 710a-710c have a relatively low refractive index, as compared to that of the light guide core 610. For example, if the light guide core 610 is formed of glass, with an index of refraction of approximately 1.51, the indices of refraction of the color filters 710a-710c may be less than 1.42. Because the color filters 710a-710c may be formed by combining two or more materials, this relatively low index of refraction may be achieved in various ways. In some implementations, the color filter material itself may have a relatively low refractive index, as compared to that of the light guide core 610. Alternatively, or additionally, the color filter material may be incorporated into material having a low index of refraction. In some implementations, a binder material used to hold the color filter material in place may have a low refractive index. For example, the binder material may include one or more low-index polymers, such as fluorinated low-index polymers.

The refractive index of the cladding layer can be calculated to match the light source emission properties of the light source system 630. FIG. 7B shows an example of light traveling within a light guide. In this example, n_{g}, the index of refraction of the light guide core 610, is sufficiently greater than the refractive index n_{c} of the cladding layer 615 to allow total internal reflection within the light guide 605. The critical angle θ_{c} shown inside the light guide core 610 is given by sin θ_{c}=n_{c}/n_{g}. Any angle bigger than this will be guided. This range can be matched to the angular range of the light coupled into the guide.

For example, if the light source system 630 includes an LED with an emission cone (into air) that has a half angle of θ_{LED}, then the refractive index n_{c} of the cladding layer 615 can be shown to be upper bounded by the following expression:

n_{c}=\sqrt{n_{g}²−sin²θ_{LED}}

As an example, if n_{g}=1.51 and the emission cone half-angle is 30 degrees, then the index of refraction of the cladding layer 615 n_{c} should be less than 1.42.

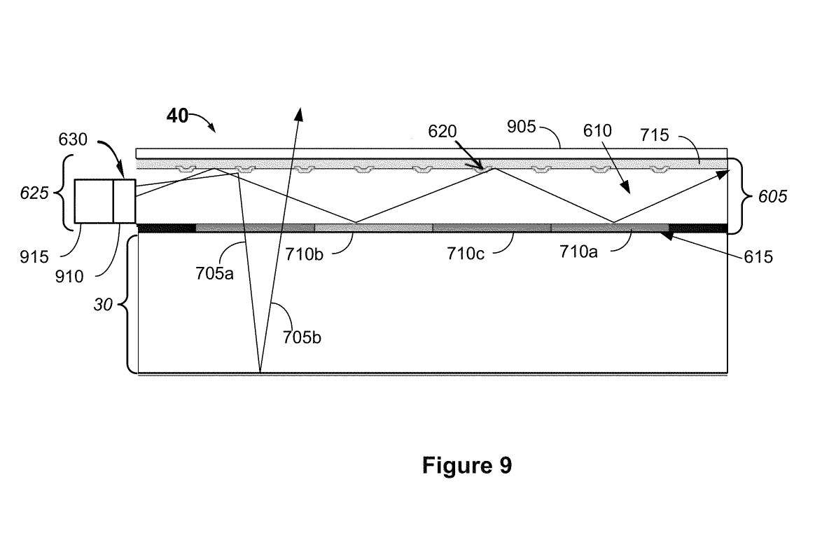

In some implementations, the color filter material may include nanoparticles and/or absorptive dyes capable of producing light of desired wavelength ranges. For example, the color filter material may include nanoparticles having sizes that are selected to resonantly absorb in narrow spectral regions. In the implementation shown in FIG. 7A, the light-extracting elements 620 are capable of extracting light from the light guide 605 and providing extracted light 705a to a display via the color filters 710a, 710b and 710c. In this example, the light-extracting elements 620 extend partially into the light guide core 610. However, in alternative examples, the light-extracting elements 620 may be disposed at least partially within a cladding layer, such as the cladding layer 715. Some examples are shown in FIGS. 9 and 10.

FIG. 7C is a cross-section through an alternative example of a front light system. In this example, the cladding layer 615 includes two sub-layers. The sub-layer 720 is a low refractive index layer, which may have an index of refraction in the range of 1.36 to 1.49 in some examples. In some implementations, the sub-layer 720 may have an index of refraction in the range of 1.36 to 1.41. The sub-layer 720 is a spin-on glass (SOG) layer in this example. The SOG may include a mixture of SiO₂ and dopants (such as boron or phosphorous). In this implementation, the sub-layer 725 includes color filters, which may or may not be formed of low-index material.

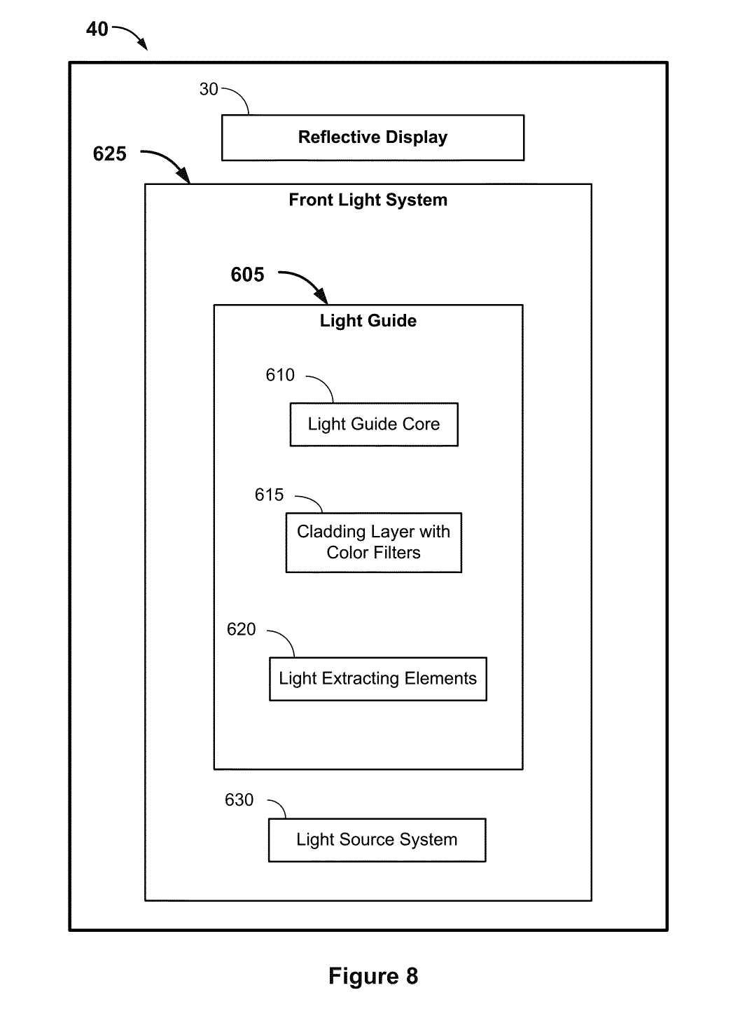

FIG. 8 is a block diagram that illustrates examples of display device elements. In this example, the display device 40 includes a display 30, which is a reflective display in this example. In this implementation, the display device 40 includes a front light system 625 such as that shown in FIG. 6B. The front light system 625, in turn, includes a light guide 605 such as that shown in FIG. 6A. Accordingly, the light guide 605 includes a light guide core 610, a cladding layer 615 having color filters, and light-extracting elements 620.

FIG. 9 is a cross-section through an example of a display device such as that shown in FIG. 8. In this example, the display device 40 includes a front light system 625 and a display 30, which is a reflective display in this example. The front light system 625 includes a light guide 605 that has a light guide core 610, a cladding layer 615 with color filters for the display 30, and light-extracting elements 620. In this example, the cladding layer 615 is disposed between the light guide core 610 and the display 30 and has a lower refractive index than that of the light guide core 610. In this implementation, the light-extracting elements 620 are capable of extracting at least some of the light 705 from the light guide and providing extracted light 705a to the display 30, via the color filters in the cladding layer 615.

Various implementations disclosed herein include a polarizing element disposed on at least one surface of the light guide 605. In the example shown in FIG. 9, the front light system 625 includes two such polarizing elements. One polarizing element is the polarizing layer 905, which may be a plastic or glass polarizing film in some implementations. In some examples, the polarizing layer 905 may include cellulose triacetate (CTA). A cladding layer 715 is disposed between the light guide core 610 and the polarizing layer 905. In some implementations, the cladding layer 715 may include an adhesive layer, such as optically clear resin (OCR) or optically clear adhesive (OCA), which may be in the range of 20-50 microns thick. These materials can be selected to have a sufficiently low index of refraction to act as a cladding layer. However, in other implementations, the cladding layer 715 may include SOG, a low-index polymer, etc. In the example shown in FIG. 9, the polarizing layer 905 is substantially parallel to a plane of the light guide core 610. In this example, the polarizing layer 905 is capable of polarizing the reflected light 705b from the display 30.

Another polarizing element is disposed on a different surface of the light guide 605, which includes a surface of the light guide core 610. In this example, the polarizer 910 is part of the light source system 630, and is disposed between a light source 915 and the light guide core 610. In this implementation, the polarizer 910 may include a plastic, glass or other material that is capable of polarizing light from the light source 915. Accordingly, the light source system 630 is capable of providing polarized light to the light guide 605. Therefore, the extracted light 705a, provided to the display 30 via the color filters 710a, 710b and 710c, is polarized light in this example.

In the example shown in FIG. 9, the light-extracting elements 620 extend partially into the cladding layer 715. In this implementation, the light-extracting elements 620 are formed, at least in part, of conductive material, such as a conductive metal. According to some such implementations, the light-extracting elements may include electrodes, such as electrodes of a touch sensor system. In some implementations, the electrodes may include auxiliary structures such as those described above. In some implementations, the electrodes (including the light-extracting elements 620) and the cladding layer 715 may be fabricated on the light guide core 610 during a process of fabricating the light guide 605. Alternatively, the electrodes and the cladding layer 715 may be fabricated separately from the light guide 605. For example, the electrodes and the cladding layer 715 may be fabricated, with or without the polarizing layer 905, as part of a film that may be applied to a surface of the light guide core 610.

FIG. 10 is a cross-section through an alternative example of a display device such as that shown in FIG. 8. In this example, the display device 40 includes a front light system 625 and a display 30, which is a reflective LCD display in this example.

In the implementation shown in FIG. 10, the display 30 includes a liquid crystal layer 1015 disposed between a passivation layer 1020 and a substantially transparent electrode layer 1025. The electrode layer 1025 may, for example, be formed at least in part from indium tin oxide (ITO). This implementation also includes spacers 1030, which are capable of containing the liquid crystal layer 1015 and providing structural support.

In this example, the front light system 625 also includes a light guide 605 that has a light guide core 610 and a cladding layer 615. In this example, the cladding layer 615 includes color filters 710a, 710b and 710c, which are formed of color filter material in a low-index binder. In this implementation, the light-extracting elements 620 are capable of extracting at least some of the light 705 from the light guide and providing extracted light 705a to the display 30, via the color filters color filters 710a, 710b and 710c. In some implementations, the light-extracting elements 620 are formed, at least in part, of conductive material, such as a conductive metal. According to some such implementations, the light-extracting elements may include electrodes, such as electrodes of a touch sensor system.

In this example, the front light system 625 includes a light source system 630 having a polarizer 910 disposed between a light source 915 and the light guide core 610. In this example, the light source 915 includes one or more light-emitting diodes (LEDs). Accordingly, the extracted light 705a is polarized.

In the implementation shown in FIG. 10, the display 30 includes an array of mirror electrodes 1035. The mirror electrodes 1035 are capable of reflecting extracted light 705a that has traversed the liquid crystal layer 1015 back through the liquid crystal layer 1015. Moreover, in this example the mirror electrodes 1035, along with electrodes of the electrode layer 1025, are capable of controlling polarization states of light 705 that traverses the corresponding portions of the liquid crystal layer 1015, according to control signals from the control system. These portions of the liquid crystal layer 1015 may correspond to pixels or subpixels of the display 30. Taken together, these pixels or subpixels form an array of display pixels.

This implementation also includes isolation metal elements 1040 disposed between the mirror electrodes 1035. The isolation metal elements 1040 may be capable of reducing the capacitive coupling between adjacent mirror electrodes 1035.

The display 30 includes an array of pixel circuits 1005, which include thin-film transistors (TFTs) in this example. Here, the pixel circuits 1005 are disposed on a substrate 1010, which may or may not be transparent.

In this implementation, the pixel circuits 1005 are capable of controlling the mirror electrodes 1035. Accordingly, the pixel circuits 1005 may be considered as elements of a control system of the display device 40. In some implementations, the control system also may include elements such as the processor 21 and/or touch controller 77, both of which are described below with reference to FIGS. 19A and 19B. The control system may be capable of processing image data and of controlling the array of display pixels according to processed image data.

In some implementations, the control system may include other elements, some of which are also described below with reference to FIGS. 19A and 19B. For example, the control system may include a driver circuit capable of sending at least one signal to the array of display pixels, a controller capable of sending at least a portion of the image data to the driver circuit and/or an image source module capable of sending the image data to the control system. The image source module may, for example, include a memory device, a network interface, a receiver, a transceiver and/or a transmitter.

In this example, the front light system 625 includes a polarizing layer 905. Accordingly, the reflected light 705b will be transmitted through, and polarized by, the polarizing layer 905 before emerging from the display device 40.

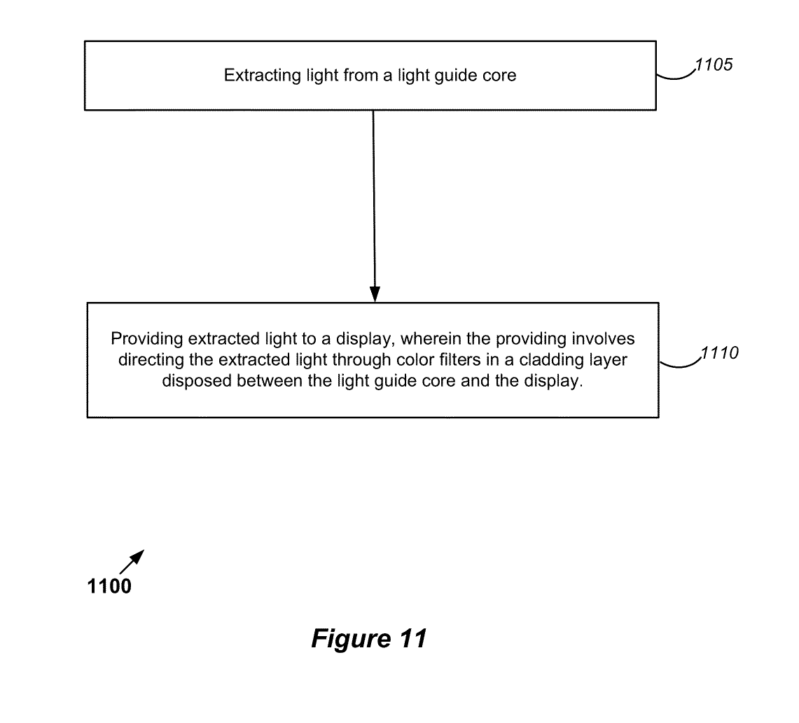

FIG. 11 is a flow diagram that provides an example of a method of using a front light system. In this example, the method 1100 begins with block 1105, which involves extracting light from a light guide core. In some implementations, the extracting process of block 1105 may be performed, at least in part, by light-extracting elements such as those described elsewhere herein.

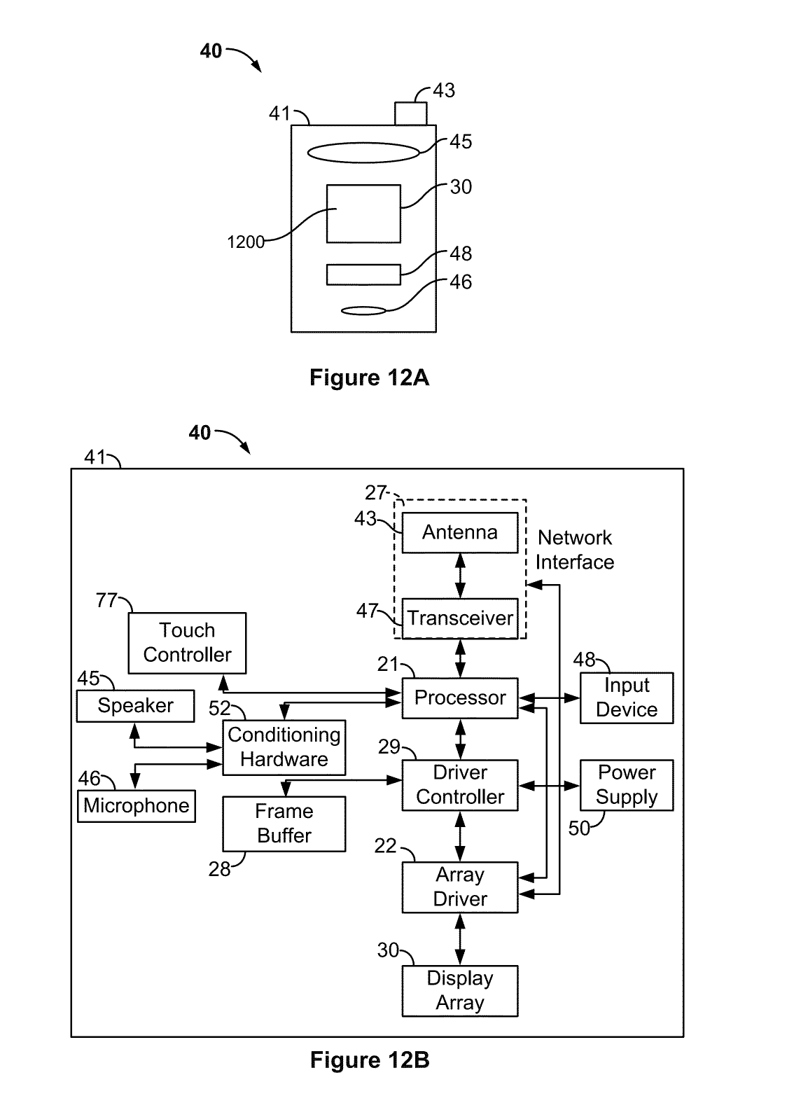

In some implementations, as noted above, light-extracting elements of a front light system may be formed of conductive material and may form at least a portion of an array of touch sensor electrodes. Accordingly, in some implementations, the method 800 may involve controlling the light-extracting elements to function as electrodes of a touch sensor system. The controlling process may be performed, for example, by one or more components of a control system, such as the touch controller 77 described below with reference to FIG. 12B.

In this implementation, block 1110 involves providing extracted light to a display. In this example, the providing involves directing the extracted light through color filters in a cladding layer disposed between the light guide core and the display. In some implementations, the extracted light may be polarized. In such implementations, the method involves providing polarized light to the display. In some instances, the display the may be a reflective display. The method also may involve polarizing light reflected from the reflective display.

FIGS. 12A and 12B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, a touch sensor device 1200, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The touch sensor device 1200 is disposed on a surface of the display 30 in this example. The touch sensor device 1200 may, in some implementations, include electrodes that are formed, at least in part, by light-extracting elements of a light guide.

The components of the display device 40 are schematically illustrated in FIG. 12B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

In this example, the display device 40 also includes a touch controller 77. The touch controller 77 may be configured for communication with the touch sensor device 1200 and/or configured for controlling the touch sensor device 1200. Accordingly, the touch controller 77 and the touch sensor device 1200 may be considered as components of a touch sensor system. The touch sensor system may be part of a user interface system for the display device 40. The touch controller 77 may be configured to determine a touch location of a finger, a conductive stylus, etc., proximate the touch sensor device 1200. The touch controller 77 may be configured to make such determinations based, at least in part, on detected changes in capacitance in the vicinity of the touch location. In alternative implementations, however, the processor 21 (or another such device) may be configured to provide some or all of this functionality. Accordingly, the touch controller 77 and the processor 21 may be considered to be elements of a control system of the display device 40.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus capable of providing light to a display, the apparatus including a light guide that comprises:
a light guide core;
a first cladding layer disposed between the light guide core and the display, the first cladding layer having a lower refractive index than that of the light guide core, the first cladding layer including color filters for the display; and
light-extracting elements capable of extracting light from the light guide and providing extracted light to the display via the color filters.

2. The apparatus of claim 1, wherein the first cladding layer comprises:
binder material having a lower refractive index than that of the light guide core; and
color filter material in the binder material, the color filter material including at least one of nanoparticles or absorptive dyes.

3. The apparatus of claim 1, wherein the first cladding layer comprises:
a low refractive index sub-layer; and
a sub-layer of color filters.

4. The apparatus of claim 3, wherein the sub-layer has a refractive index in the range of 1.36 to 1.41.

5. The apparatus of claim 1, further including a light source system capable of providing polarized light to the light guide.

6. The apparatus of claim 1, wherein the light-extracting elements include electrodes.

7. The apparatus of claim 6, wherein at least some of the electrodes are electrodes of a touch sensor system.

8. The apparatus of claim 1, wherein the apparatus includes a reflective display.

9. The apparatus of claim 8, wherein the reflective display includes a liquid crystal layer.

10. The apparatus of claim 8, further including a polarizing element disposed on at least one surface of the light guide.

11. The apparatus of claim 10, wherein the polarizing element is a polarizing layer that is substantially parallel to a plane of the light guide core.

12. The apparatus of claim 11, further including a second cladding layer disposed between the light guide core and the polarizing layer.

13. The apparatus of claim 12, wherein the light extracting elements are disposed on the second cladding layer.

14. The apparatus of claim 10, wherein the polarizing element is disposed between the light guide and a light source of the light source system.

15. The apparatus of claim 8, wherein the reflective display includes an array of display pixels, further including a control system that is capable of processing image data and of controlling the array of display pixels according to the processed image data.

16. The apparatus of claim 15, wherein the control system further comprises:
a driver circuit capable of sending at least one signal to the array of display pixels;
a controller capable of sending at least a portion of the image data to the driver circuit; and
an image source module capable of sending the image data to the control system, wherein the image source module includes at least one of a memory device, a network interface, a receiver, a transceiver or a transmitter.

17. The apparatus of claim 15, further comprising:
an input device capable of receiving input data and of communicating the input data to the control system.

18. A front light system capable of providing light to a display, the front light system comprising:
a light guide, the light guide including:
a light guide core;
a first cladding layer disposed between the light guide core and the display, the first cladding layer having a lower refractive index than that of the light guide core, the first cladding layer including color filters for the display; and
light-extracting means for extracting light from the light guide and providing extracted light to the display via the color filters; and
light source means for providing light to the light guide.

19. The front light system of claim 18, wherein the first cladding layer comprises:
low refractive index material; and
color filter material.

20. The front light system of claim 19, wherein the low refractive index material has a refractive index in the range of 1.36 to 1.41.

21. The front light system of claim 18, wherein the front light system includes means for providing polarized light to the light guide.

22. The front light system of claim 18, wherein the display is a reflective display and wherein the front light system includes means for polarizing light reflected from the reflective display.

23. The front light system of claim 18, wherein the light-extracting means includes electrodes.

24. The front light system of claim 23, wherein at least some of the electrodes are electrodes of a touch sensor system.

25. An apparatus, comprising:
a reflective display; and
a front light system capable of providing light to the reflective display, the front light system including:
a light guide, the light guide including:
a light guide core;
a first cladding layer disposed between the light guide core and the display, the first cladding layer having a lower refractive index than that of the light guide core, the first cladding layer including color filters for the display; and
light-extracting elements capable of extracting light from the light guide and providing extracted light to the display via the color filters; and
a light source system capable of providing light to the light guide.

26. The apparatus of claim 25, wherein the first cladding layer comprises:
low refractive index material; and
color filter material.

27. The apparatus of claim 26, wherein the low refractive index material has a refractive index in the range of 1.36 to 1.41.

28. The apparatus of claim 25, wherein the front light system includes means for providing polarized light to the reflective display.

29. The apparatus of claim 25, wherein the front light system includes means for polarizing light reflected from the reflective display.

30. The apparatus of claim 25, further including a second cladding layer disposed between the light guide core and the apparatus for polarizing light reflected from the reflective display.

31. The apparatus of claim 25, wherein at least some of the light-extracting elements are capable of functioning as electrodes.

32. The apparatus of claim 31, wherein at least some of the electrodes are electrodes of a touch sensor system.

33. A method, comprising:
extracting light from a light guide core; and
providing the extracted light to a display, wherein the providing involves directing the extracted light through color filters in a cladding layer disposed between the light guide core and the display.

34. The method of claim 33, wherein the extracting is performed by light-extracting elements and wherein the method further involves controlling the light-extracting elements to function as electrodes of a touch sensor system.

35. The method of claim 33, further involving providing polarized light to the display.

36. The method of claim 33, wherein the display is a reflective display, the method further involving polarizing light reflected from the reflective display.
